(19) United States
(12) Patent Application Publication
(10) Pub. No.: US 2005/0000618 A1
(43) Pub. Date: Jan. 6, 2005

(54) Method for joining plastic structural component parts by means of laser radiation

(75) Inventors: Hans-Ulrich Zuehlke, Jena (DE); Gabriele Eberhardt, Jena (DE); Norbert Preuss, Jena (DE)

Correspondence Address: Gerald H. Kiel, Esq.;REED SMITH, LLP, 599 Lexington Avenue, New York, NY, 10022-7650, US

(73) Assignee: JENOPTIK Automatisierungstechnik GmbH

(21) Appl. No.: 10/619,392

(22) Filed: Jul. 14, 2003

(30) Foreign Application Priority Data
Jul. 16, 2002 (DE) 102 32 727.0

(51) Int. Cl. B29C 65/16; B29C 65/14; B29C 65/02

(52) U.S. Cl. 156/66; 156/272.8; 156/379.9; 156/380.9

(57) ABSTRACT

In a method for joining plastic structural component parts by laser radiation, it is the object of the invention to prevent impairment of the surface quality by the falling in of material of the quality surface in thin-walled plastic structural component parts when the latter are connected to another part. A first thin-walled plastic structural component part having a quality surface is formed so as to be absorbent for the laser radiation and is welded by the transmission radiation method on a side located opposite from the quality surface to a second plastic structural component part which is transparent to the laser radiation. The transparent plastic structural component part is heated beforehand in order to reduce the temperature gradient between the plastic structural component parts when joining, so that a faster melting of the transparent plastic structural component part is carried out by heat conduction during joining, and a thermal expansion in the absorbing plastic structural component part in the direction of the quality surface is limited.

### CROSS-REFERENCE TO RELATED APPLICATIONS

This application claims priority of German Application No. 102 32 727.0, filed Jul. 16, 2002, the complete disclosure of which is hereby incorporated by reference.

### BACKGROUND OF THE INVENTION

a) Field of the Invention

The invention is directed to a method for joining plastic structural component parts by means of laser radiation, in which a first thin-walled plastic structural component part having a quality surface is formed so as to be absorbent for the laser radiation and is welded by the transmission radiation method to a second plastic structural component part which is transparent to the laser radiation on a side located opposite from the quality surface.

b) Description of the Related Art

Automobile body parts are increasingly design elements which are formed as plastic covers to ensure a high surface quality and are constructed with very thin walls in order to economize on materials and reduce weight. In the supplier industry above all, this leads to an ever increasing occurrence of problems in joining because reinforcement elements or holding elements must be connected to thin-walled thermoplastic parts and a high surface quality must often be ensured.

It has been known for some time to connect thermoplastic plastics through laser welding by the transmission method. For this purpose, it is necessary that one of the parts is transparent and the other part is absorbent for the laser radiation being used. The laser radiation penetrates the transparent part and melts the absorbent part on the surface. The expanding melt enters into connection with the transparent part so that the latter is likewise melted by means of the resulting heat transfer. As a result, a weld connection is formed because of the penetration of the two melts.

A method of this kind which is directed to the production of a permanent connection between a flat, light plastic structural component part with a quality surface and an element is known, e.g., from the generic DE 100 59 160 A1. The element is transparent to the laser light at least in partial areas, whereas the light plastic structural component part absorbs the laser light and it is required that the energy received by the light plastic structural component part through light absorption is to be selected in such a way that neither the geometric nor the material constitution of the quality surface is impaired.

In spite of the small penetration depth of the laser radiation, which is typically between 0.01 mm and 0.2 mm depending on material, it has been shown that with thin-walled plastic structural component parts with a material thickness of less than 2 mm there is a thermal influence on the material thickness throughout and the surface quality is impaired on the side with the quality surface due to the falling in of material. This negative effect can also not be prevented by steps that are known from DE 100 59 160 A1.

### OBJECT AND SUMMARY OF THE INVENTION

Therefore, it is the primary object of the invention to prevent impairment of the surface quality by the falling in of material of the quality surface in thin-walled plastic structural component parts when the latter are connected to another part.

According to the invention, this object is met by a method of the type mentioned in the beginning in that the transparent plastic structural component part is heated beforehand in order to reduce the temperature gradient between the plastic structural component parts when joining, so that a faster melting of the transparent plastic structural component part is carried out by heat conduction during joining, and a thermal expansion in the absorbing plastic structural component part in the direction of the quality surface is limited.

As a result of the present invention, a weld connection is formed without impairment of the quality surface of the thin-walled plastic structural component part, since the time for producing the joint connection is shortened and the depth to which the heat conduction process penetrates into the material is reduced. This prevents thermal influencing of the entire material thickness which occurs in the known methods with thin-walled materials having a thickness of 1 mm to 2 mm.

In the present invention, the transparent plastic structural component part serves as a carrier part for reinforcing or stiffening the thin-walled plastic structural component part and also serves to fasten it.

In a preferred construction, the transparent plastic structural component part is heated by a separate heat source. This can also be omitted in the present invention when the material of the transparent plastic structural component part is composed in such a way that the heating is brought about even by a partial absorption of laser radiation or a laser wavelength.

This is especially important when a broadband NIR radiator is used as radiation source, since the heating can then be brought about by wavelength-selective forming of the absorption characteristics and transmission characteristics of the material.

In principle, wavelengths of 700 nm to 1200 nm are suitable for laser welding by the transmission method.

The invention will be described more fully in the following with reference to the schematic drawing.

### BRIEF DESCRIPTION OF THE DRAWINGS

In the drawings:

FIG. 1. shows two plastic structural component parts before joining, one of them being transparent to the laser radiation and preheated by a separate heat source; and

FIG. 2 shows an arrangement for joining two plastic structural component parts.

### DESCRIPTION OF THE PREFERRED EMBODIMENTS

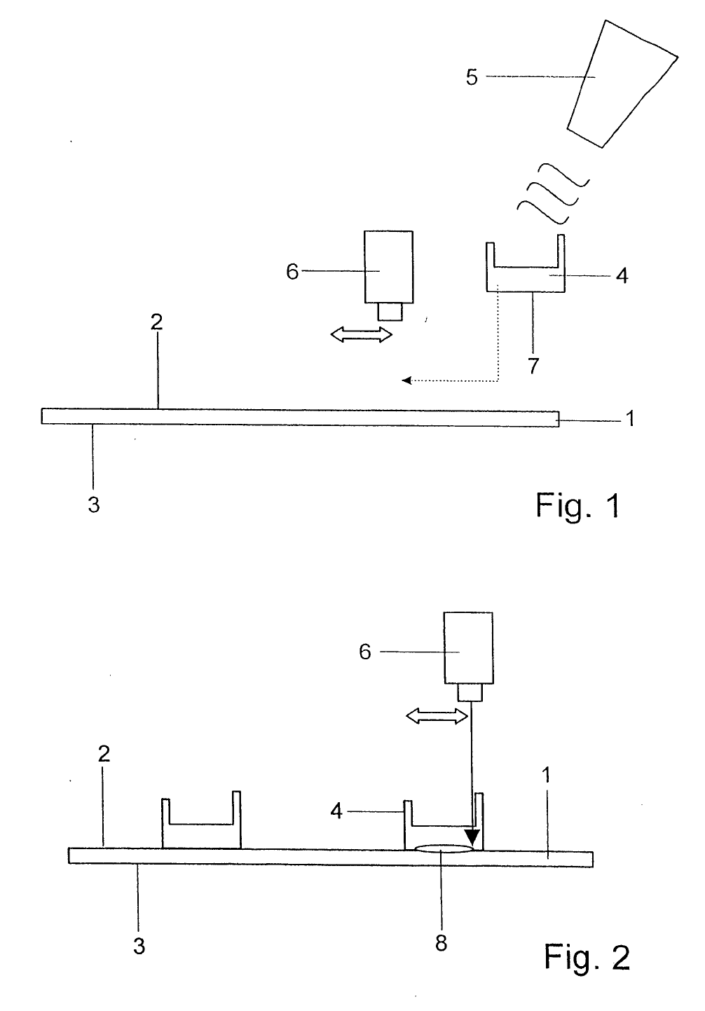

One of the plastic structural component parts shown in FIG. 1 is a thin-walled injection-molded part 1 having a quality surface 3 opposite from a joint surface 2 and is fabricated from a polymer material which absorbs a laser beam used in the transmission method of laser welding. The other plastic structural component part 4 which is preferably made from the same polymer as the injection-molded part 1 is heated to a temperature of about 50° C. below its melting point by means of a heat radiator 5 and is then placed in the position required for joining with the injection molded part 1.

The two plastic structural component parts 1 and 4 are fixed relative to one another by a mechanical holding device, not shown, and are welded together accompanied by the action of laser radiation from a laser radiation source 6 which can be constructed, e.g., as a high-power diode laser. The dimension of the gap between the joint surface 2 and a joint surface 7 of the plastic structural component part 4 should be as small as possible to allow the transparent plastic structural component part 4 to melt.

The laser radiation source 6 can be displaced at least in one coordinate along a weld connection 8 to be generated, indicated by an arrow. Naturally, the system operates more flexibly by means of an x-y adjusting device, not shown.

Optics which are also not shown serve to shape the laser beam to form a suitable weld geometry.

While the foregoing description and drawings represent the present invention, it will be obvious to those skilled in the art that various changes may be made therein without departing from the true spirit and scope of the present invention.

1. A method for joining plastic structural component parts by means of laser radiation, comprising the steps of:
forming a first thin-walled plastic structural component part having a quality surface so as to be absorbent for the laser radiation;
welding said component part by the transmission radiation method to a second plastic structural component part which is transparent to the laser radiation on a side located opposite from the quality surface;
heating the transparent plastic structural component part beforehand in order to reduce the temperature gradient between the plastic structural component parts when joining, so that a faster melting of the transparent plastic structural component part is carried out by heat conduction during joining, and a thermal expansion in the absorbing plastic structural component part in the direction of the quality surface is limited.

2. The method according to claim 1, wherein the transparent plastic structural component part is heated by a separate heat source.

3. The method according to claim 1, wherein the material of the transparent plastic structural component part is composed in such a way that the heating is brought about even by a partial absorption of laser radiation or a laser wavelength.

4. The method according to claim 1, wherein the transmission method is carried out with laser radiation in the wavelength range of 700 nm to 1200 nm.

5. The method according to claim 4, wherein the transmission welding method is carried out with a broadband NIR radiator.

6. The method according to claim 1, wherein the transparent plastic structural component part serves to reinforce or stiffen the thin-walled plastic structural component part.

7. The method according to claim 1, wherein the transparent plastic structural component part serves to fasten the thin-walled plastic structural component part.
